(19) United States
(12) Patent Application Publication
(10) Pub. No.: US 2006/0207628 A1
(43) Pub. Date: Sep. 21, 2006

(54) Rubber floss

(76) Inventor: Charles Ray Millis, Fort Wayne, IN (US)

Correspondence Address: Charles Millis, 7027 Melody Lane, Fort Wayne, IN, 46804, US

(21) Appl. No.: 11/287,020

(22) Filed: Nov. 28, 2005

Related U.S. Application Data
(60) Provisional application No. 60/661,808, filed on Mar. 16, 2005.

(51) Int. Cl. A61C 15/00

(52) U.S. Cl. 132/321

(57) ABSTRACT

Rubber Floss is a dental floss made from rubber and sulfur. Rubber Floss is a material that would not come apart between the teeth like all other flosses that are woven together. Rubber Floss is soft and would not cut or hurt the gums as other flosses can do. The main advantage to using Rubber Floss is that once the floss is stretched out and placed between the teeth and the tension released it will expand and fill the gap between the teeth allowing the floss to clean away the food particles from both sides of each tooth. There is no other floss on the market that can expand and clean in this manner.

Rubber Floss, application Ser. No. 11/287,020, is a rubber strip to clean between the teeth. The rubber strip would be made from rubber and sulfur. The rubber strip would be 5 inches long and have a circumference of 0.040 inches.

Rubber Floss is used by stretching it out and wrapping it around the middle finger on each hand. The tighter the Rubber Floss is stretched the thinner it will become. Rubber Floss is then placed between the teeth and the tension released allowing it to expand and fill the gap between the teeth. Pulling Rubber Floss back and forth between the teeth will clean both sides of each tooth.

What I claim as my invention is dental floss made from rubber and sulfur:

I. Floss made of rubber and sulfur will not cut or hurt the gums.

II. Floss made of rubber and sulfur will not come apart and get caught between the teeth.

III. Floss made of rubber and sulfur will expand and fill the gap between the teeth cleaning both sides of each tooth.
